(19) United States
(12) Patent Application Publication
(10) Pub. No.: US 2009/0047493 A1
(43) Pub. Date: Feb. 19, 2009

(54) Woven/knit fabric of carbon fiber monofilament and use thereof

(76) Inventors: Kazuo Kitagawa, Kyoto (JP); Hironori Fukuoka, Kyoto (JP); Syoji Zaiki, Kyoto (JP)

Correspondence Address: KIRSCHSTEIN, OTTINGER, ISRAEL;& SCHIFFMILLER, P.C., 425 FIFTH AVENUE, 5TH FLOOR, NEW YORK, NY, 10016-2223, US

(21) Appl. No.: 11/665,611

(22) PCT Filed: Oct. 19, 2005
(86) PCT No.: PCT/JP05/19224

§ 371 Date: Apr. 17, 2007

(30) Foreign Application Priority Data
Oct. 19, 2004 (JP) 2004-303759

(51) Int. Cl. B32B 5/00; D03D 25/00; D04B 1/00

(52) U.S. Cl. 428/220; 442/189; 442/308

(57) ABSTRACT

A completely new cloth of utility is provided by using a carbon fiber monofilament. A woven or knitted cloth was prepared at a density of 5 to 1800 yarns per inch by using a carbon fiber monofilament of a diameter of 10 μm or less as a single yarn. This cloth can be practically used widely in the fields of precise equipments and medical care, as an ultrathin sheet having biocompatibility and electroconductivity.

### TECHNICAL FIELD

The present invention relates to woven or knitted carbon fiber clothes by using a carbon fiber monofilament as a single yarn, and their uses.

### BACKGROUND TECHNOLOGY

Carbon fiber has a lower specific gravity than that of metal; has high Young's modulus, has thermal conductivity; is excellent in chemical resistance and heat resistance; has biocompatibility; is excellent in electroconductivity and electromagnetic wave shielding property advantageously, and therefore is used for very wide applications.

In general, carbon fiber is supplied as multifilament yarns and used by being prepared into uni-directional fibers and textiles in many cases. Although it has high tensile strength, it has low knot strength and is easily broken disadvantageously. Therefore, for cloth formation, as shown, for example, in Patent Document 1, it is often used in fabrics for manufacturing the prepreg as fiber bundles of 1 to 24K usually. A carbon fiber monofilament has not been used as a single yarn, and has not been prepared into thin clothes of 100 μm thick or less.

### Patent Document 1: Japan Laid-open Patent Publication No. 2003-268650

### DISCLOSURE OF THE PRESENT INVENTION

### Problems to be Solved

The object of the present invention is to use such a carbon fiber as a monofilament alone to develop a completely new cloth and its use.

### Means for Solving the Problem

In the present invention, carbon fiber was used as a monofilament of a diameter of 10 μm or less, and by using it as a single yarn, a woven or knitted carbon fiber cloth having a density of 5 to 1800 yarns per inch was made to solve the above-mentioned problem.

In such present invention, it is possible to give a cloth of as very thin as 20 μm or less. Such an ultrathin cloth assimilates to surroundings as it consists of black carbon fiber monofilaments, and becomes usually invisible. In such a sense, it becomes to be a transparent cloth. However, it can exert sufficiently the performances original to carbon fiber such as high mechanical modulus and strength, thermal conductivity, X-ray transmission, heat ray absorption- and adsorption-ability.

Furthermore, an ultrathin plastic sheet reinforced by such a cloth can develop the uses in the fields of ultra precision equipments such as IT-related electron equipments, aviation, cosmos, automobile and sports. For example, a plastic sheet reinforced by carbon fibers can be prepared into a very thin sheet of 0.5 mm thick or less, especially 0.2 mm thick or less.

Further, the diameter of the carbon fiber monofilament used in the present invention is preferably 10 μm or less, and usually 3 μm or more, especially about 5 to 10 μm, 7 to 8 μm.

The cloth by using such carbon fiber monofilaments may be a woven stuff or a knitted fabric and may be a lace or a net. Usually, it is preferred to use a carbon fiber monofilament as a single yarn to give a density of 5 to 1800 yarns per inch, especially about 8 to 1500 yarns per inch.

The cloth consisting of carbon fiber monofilaments of the present invention can be used efficiently as a reinforcement for reinforced plastic. For this purpose, for example, a thermosetting resin such as epoxy resin and unsaturated polyester and a thermoplastic resin such as nylon, polyolefin and polyester are permeated to or laminated on a cloth consisting of carbon fiber monofilaments to give a very thin sheet of reinforced plastics. Also, a reinforced plastic product having a three dimensional form such as a pipe form can be produced by using such prepreg. Further, for the preparation of such a reinforced plastic, carbon fiber monofilaments can be uni-directionally arranged individually at the above-mentioned density and used as an uni-directional reinforcement.

In the case of the carbon fiber monofilaments being arranged and used as an uni-directional material, the density is preferably 5 to 3600 yarns, especially about 100 to 3600 yarns per inch.

Furthermore, the cloth of the present invention can be used as a biocompatible textile material. In this case, it is preferably prepared into an ultrathin cloth which can not visually been confirmed, and the density of the filament is preferably about 10 to 500 yarns per inch.

### Effect of the Invention

As the cloth of the present invention consists of carbon fibers, it is excellent in dimensional stability and also excellent in mechanical strength and also has excellent characteristics such as biocompatibility, chemical stability, thermal resistance and electroconductivity. Furthermore, as the carbon fibers are used as a very fine monofilament, an ultrathin cloth which is invisible can be prepared from them. As the result, as a biocompatible textile material, it does not inhibit cell growth, has high mechanical strength and has softness, and can be used very efficiently without making a person be aware of its uses visually.

Also, the plastic sheet reinforced by ultrathin clothes (or uni-directional reinforcements made by arranging individually carbon fiber monofilaments) having a thickness as thin as 20 μm or less has a proper mechanical strength even at a thickness of 0.5 mm or less. Furthermore, as a sheet having functionalities such as electroconductivity, electric wave shieldability, heat ray absorbing ability, X-ray transmission, thermal conductivity and adsorptive ability, it can be widely used in the fields of ultra precision equipments such as IT-related electronic equipments, aviation, cosmos, automobile and sports.

### BEST EMBODIMENTS FOR EXECUTING THE INVENTION

### Example 1

Carbon fiber monofilaments having a diameter of 7 μm were woven into a textile good having a plain weave structure at a density of 12 yarns per inch in both warp and weft directions. The presence of this textile good cannot be visually confirmed by all of ten monitors.

The textile good was used as a biocompatible adhesion-inhibiting film.

### Example 2

Carbon fiber monofilaments having a diameter of 7 μm were woven into a textile good having a plain weave structure at a density of 24 yarns per inch in both warp and weft directions.

Silicone resin was permeated to this textile good to give a reinforced plastic sheet of 0.2 mm thickness. It could be used effectively as an electroconductive sheet of heat resistance.

### Example 3

Carbon fiber monofilaments having a diameter of 7 μm were woven into a textile good having a twill structure at a density of each 1 mm pitch (10 yarns per cm) in both weft and warp direction. This textile good became to a thin cloth which cannot be visually confirmed and can be used as a biocompatible adhesion-inhibiting film as those described in Example 1.

Furthermore, by using same carbon fiber monofilaments, a twill textile good was prepared at densities of 0.5 mm pitch (20 yarns per cm) and 0.2 mm pitch (50 yarns per cm) in warp and weft directions respectively. They were useful as reinforced plastics by permeating silicone resin.

### Example 4

Carbon fiber monofilaments having a diameter of 7 μm were woven into plain textile goods at densities of 1 mm pitch (10 yarns per cm), 0.5 mm pitch (20 yarns per cm) and 0.2 mm pitch (50 yarns per cm) respectively in warp and weft directions. To each of them, an acryl polyurethane resin (V Top Clear made by Dainippon Toryo Co., Ltd.) diluted with a solvent to 15 to 20 weight % as a matrix resin was permeated and then cured at room temperature for 20 hours to give a very thin carbon fiber/resin sheet of 59-84 μm thickness.

The very thin reinforced plastic sheets using the clothes according to the present invention as the reinforcing material have high Young's modulus and are high in thermal conductivity, that is, high in heat radiation, and are also excellent in electromagnetic wave shielding property and thus they were used as the effective heat radiation material for electric devices. However, a resin sheet of Comparative Example is relatively low in Young's modulus and also low in thermal conductivity and the heat radiation performance was not obtained.

Here, the types of the reinforced plastic sheets prepared are shown as follows.

| Plain textile good | Reinforced plastic sheets |
|---|---|
| Pitch (mm) | Thickness (μm) |
| 1 | 59, 60, 61, 65, 63, 67 |
| 0.5 | 71, 70, 69, 73, 75, 71 |
| 0.2 | 82, 84, 79, 78, 81, 83 |
| No cloth | 50, 49, 51, 47, 48, 48 |
| (Comparative Example) | |

### Example 5

By using an uni-directional reinforcement prepared by arranging carbon fiber monofilaments of a diameter of 7 μm at a pitch of 0.5 to 0.1 mm so as to extend in one direction, an epoxy resin (Epicote 828 made by Japan Epoxy Resin Co., Ltd.) as a matrix resin, 32 phr of an alicyclic polyamine (Epicure 113 made by Japan Epoxy Resin Co., Ltd.) as a curing agent and a softener were mixed and the mixture was diluted by a solvent to 10 to 15 weight % and permeated in the uni-directional reinforcements, and then held at 45° C. for 40 minutes to give a carbon fiber monofilament prepreg of B stage. This prepreg was laminated to 4 layers with stacking at ±90° direction and vacuum bag molded under a low pressure of 1 to 2 MPa at 160° C. to give an ultra-thin carbon fiber/resin laminated composites.

The ultra-thin laminated composites made by 0.1 mm pitch material was useful as a reinforcing part for minute tools of precise bodies of revolution.

The types of laminated composites prepared are shown as follows.

| Arrangement of filaments | Laminated composites |
|---|---|
| Pitch (mm) | Thickness (μm) |
| 0.50 | 190, 180, 208, 210, 199, 220 |
| 0.25 | 241, 232, 228, 240, 239, 243 |
| 0.10 | 308, 299, 310, 315, 288, 285 |

1. A woven or knitted carbon fiber cloth using a carbon fiber monofilament of a diameter of 10 μm or less as a single yarn at a density of 5 to 1800 yarns per inch.

2. A woven or knitted carbon fiber cloth according to claim 1, in which the thickness of the cloth is 20 μm or less.

3. An ultra-thin plastic reinforced by the woven or knitted carbon fiber cloth according to claim 1.

4. A reinforced plastic according to claim 3, in which the thickness of the laminated composite is 0.5 mm or less.

5. An ultra-thin reinforced plastic using a carbon fiber monofilament having a diameter of 10 μm or less as a single yarn in the form of unidirectionally arranging them at a density of 5 to 3600 yarns per inch.

6. A biocompatible textile material consisting of the woven or knitted carbon fiber cloth according to claim 1.

7. A biocompatible textile material according to claim 6, in which the density of the carbon fiber monofilament in the cloth is 10 to 500 yarns per inch.
